(19) United States
(12) Patent Application Publication
(10) Pub. No.: US 2018/0201532 A1
(43) Pub. Date: Jul. 19, 2018

(54) PURE-SIP POINT-OF-USE WATER TREATMENT SYSTEM

(71) Applicant: John James McEncroe, Golden, CO (US)

(72) Inventor: John James McEncroe, Golden, CO (US)

(21) Appl. No.: 15/908,810

(22) Filed: Mar. 1, 2018

Related U.S. Application Data
(63) Continuation-in-part of application No. 13/998,189, filed on Oct. 3, 2013.
Application No. 13/998,189 is a continuation of application No. 12/576,645, filed on Oct. 9, 2009, now abandoned.

(51) Int. Cl. C02F 9/00; C02F 1/44; C02F 1/28; C02F 1/32

(52) U.S. Cl. CPC C02F 9/005; C02F 1/444; C02F 1/32; C02F 1/283; Y02A 20/214

(57) ABSTRACT

Endocrine disrupting compounds are routinely detected in the treated water leaving our municipal drinking water plants; however, until relatively recent advances in laboratory analysis capabilities, the trace amounts of these chemicals was not measurable. At an enormous cost we can remove these compounds using centralized municipal water treatment, but does it make sense to do so when less than 1% of our municipal water supply is ingested? Furthermore, ˜⅓ of waterborne disease outbreaks can be traced to contamination entering our water distribution systems after centralized treatment. The regulatory community and municipal water industry are truly at a crossroads; even if a staggering investment is made to remove endocrine disrupting compounds using centralized treatment, our treated water distribution systems will always be subject to contamination (and although bottled water is generally free of endocrine disrupting compounds and of high microbial purity, it may be unavailable during civil emergencies when it is most needed). The countertop (portable) “Pure Sip” low voltage Point-of-Use water treatment system uses 4 stages of filtration, and/or adsorption, and/or ion exchange, coupled with 2 stages of UV disinfection, to reliably and economically address these exposures.

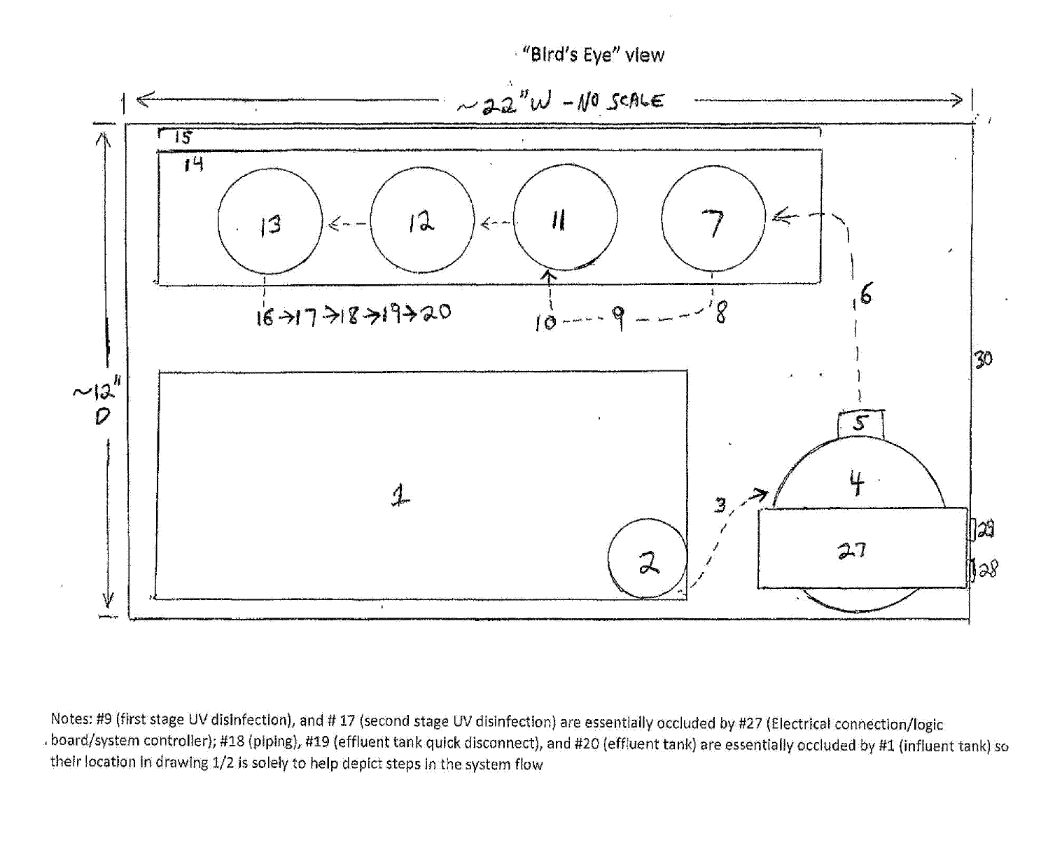

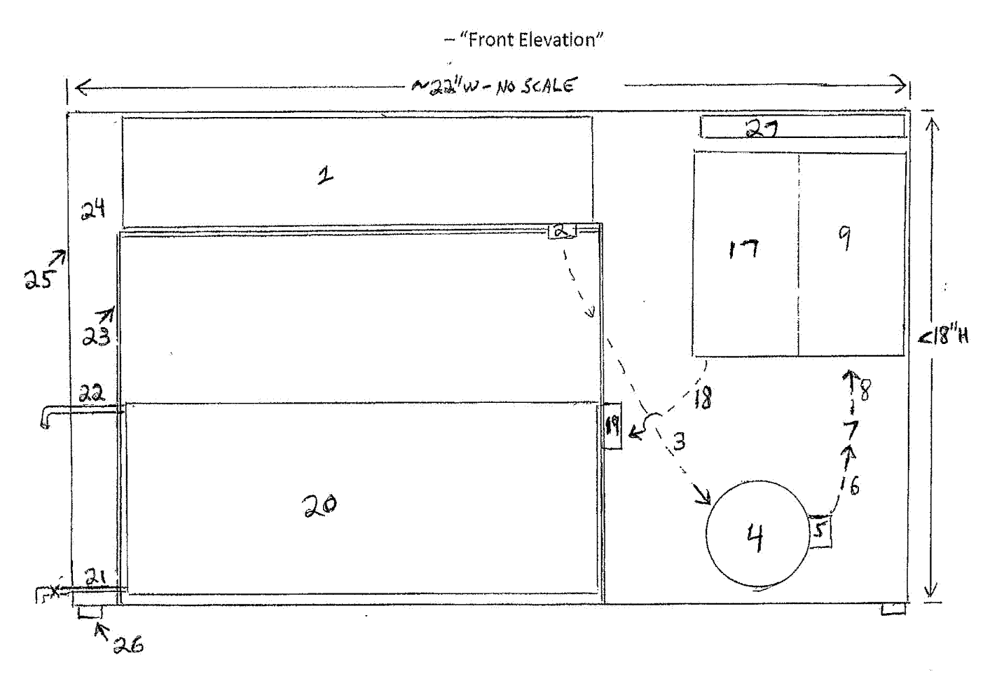

### RELATED APPLICATIONS

This application is a Continuation in Part of application Ser. No. 13/998,189 which is a continuation of application Ser. No. 12/576,645. In addition to specific comments listed below on Heiss and Saraceno, the two point-of-use water treatment systems most similar to my system, I have listed those references cited in CIP to application Ser. No. 13/998,189 on attached form sb008a:
7632410—Heiss: I am sure that Heiss' system can produce potable water, that said: p 4 of 11—claim 3: The EPA, state health agencies, and municipal water suppliers, will be quite resistant to supplying systems for homeowner use which require chemical addition under normal operating conditions. p 5 of 11—claim 23: The cost of a turbidity analyzer and total organic carbon analyzer (coupled with the cost of 2 conductivity analyzers described under claim 1 on p 4 of 11), will cost significantly more than my entire system. In order to induce the EPA, state health agencies, and municipal water suppliers to embrace a Point-of-Use system as the final barrier in the industry's multiple barrier approach to public health, a Point-of-Use system must be affordable enough to be implemented in lieu of massive future investment in centralized treatment to remove contaminants of emerging concern. p 11 of 11—Detailed Description (last paragraph): Based on the description, it is highly unlikely that the system could be modified to allow its placement in the standard 18″ area between the base cabinets and wall cabinets in a household kitchen.
6863827—Saraceno:
Per p 1, Abstract, “Maneuverability is enhanced by mounting a cabinet on wheels or on a cart . . . ” Unlike Saraceno, my system is designed to fit in the space typically found between base cabinets and wall cabinets in a kitchen such that highly purified water is readily available within the home; it is designed such that it can easily be swapped out for scheduled maintenance by the municipal water supplier.
P3 of 7—claim 14: Although Saraceno provides UV disinfection, there is only one stage. It is imperative that UV disinfection occur immediately following coarse filtration to avoid inoculating subsequent filtration processes, leading to premature clogging and/or “sloughing” in the filtration process, which can overwhelm a system with a single UV disinfection process subsequent to filtration.

### FEDERALLY SPONSORED RESEARCH OR DEVELOPMENT

On Apr. 30, 2011 I applied for a Small Business Innovation Research grant to build a prototype of “Pure-Sip;” my application was not approved.

### JOINT RESEARCH AGREEMENT

There are no parties to an approved and funded joint research agreement

### PRIOR DISCLOSURES

In addition to my application Ser. No. 13/998,189, form sb008b will be included and full copies of 5 of my national publications/presentations provided:
I. Water Technology, November 2012, “Modern Society At A Crossroads” (cover story), p 16-19
II. 2011 Water Quality Association Aquatech USA 2011 national conference, “Point-of-Use, The Final Barrier,” presentation, San Antonio Tex.
III. Water Technology, August 2011, “Point-of-Use Designed for Regulatory-Municipal Use”
IV. 2010 National Conference of the American Water Works Association, Chicago Ill., “Point-of-Use, The Final Barrier” presentation
V. Journal of the American Water Works Association, February 2007 “Point-of-Use: The Final Barrier.”

### BACKGROUND OF THE INVENTION

The system for which I seek a process patent employs existing technologies to economically produce potable water in a configuration which provides the requisite flexibility for everyday use in the home, portable use away from home, and during civil emergencies. Unlike bottled water which is processed in a controlled environment and subsequently distributed in tamper evident packaging (and which may be unavailable during civil emergencies when most needed), municipally treated water is pumped through a complicated water distribution system in which there are numerous potential places for contamination and which are not under the direct control of the water supplier. Indeed, one study found that 30.3% of waterborne disease outbreaks in the United States could be traced to our treated water distribution systems (Craun & Calderon 2001). The “Pure-Sip” Point-of-Use process can essentially eliminate outbreaks related to distribution system contamination events. In addition to concerns with contamination of treated water within our distribution systems, there are trace amounts of human made chemicals, such as endocrine disrupting compounds, which are routinely detected in the treated water leaving our municipal drinking water plants. Until relatively recent advances in laboratory analysis capabilities, the presence of trace amounts of many of these chemicals was immeasurable. Dr. Joerg Drewes (formerly at Colorado School of Mines and now at the University of Munich) stated his concern about these chemicals as follows: “In addition to concerns about individual endocrine disrupting compounds, there is concern about the cocktail effect of numerous micropollutants and/or their metabolites” (lecture notes from ESGN 603 at Colorado School of Mines, Sep. 9, 2004). Indeed, there are over 83,000 chemicals currently in the TSCA inventory (testimony before the Subcommittee on Commerce, Trade, and Consumer Protection, Committee on Energy and Commerce, House of Representatives by John Stephenson, Director Natural Resources and the Environment—GAO, Feb. 26, 2009, GAO-09-428T “Chemical Regulation, Options for Enhancing the Effectiveness of TSCA”). The regulatory community and municipal water industry are at a crossroads. At an enormous cost, we can remove these trace contaminants using centralized municipal water treatment, but does it make sense to do so when less than 1% of our municipal water supply is ingested (Vickers 2001), and when we know that ˜⅓ of disease outbreaks attributable to our potable water systems can be traced to our water distribution systems?

### BRIEF SUMMARY OF THE INVENTION

The “Pure Sip” Point-of-Use water treatment system is a logical, economical, and effective, addition to the water industry's traditional “multiple barrier” treatment strategy. Although there are numerous manufacturers of “Point-of-Use” water treatment systems, to be successful in persuading the EPA, state and local Health Departments, and municipal water suppliers to approve and employ a “Point-of-Use” system they need a free-standing countertop design which: Eliminates the nebulous variables and costs related to under-the-counter installations; is convenient for the citizen and the utility to swap out on a scheduled basis (generally every six months, but variable depending on water system quality); and which provides potable water by protecting the user against microbiological, inorganic, and organic contaminants. Although reverse osmosis systems provide a high degree of purity, healthful minerals are removed from the water and a liquid waste stream is generated which must be disposed of (typically by a connection to a drain). The “Pure-Sip” system will not remove these beneficial constituents nor will it generate a liquid waste stream. To ensure the provision of potable water, the system employs 6 physical treatment steps including: Filtration at <50 um, UV disinfection; 3 additional filtration and/or GAC adsorption and/or ion exchange cartridges at ≤3 um (inclusion of a filtration cartridge at <0.45 um will physically exclude pathogenic bacteria); and a second UV disinfection process following filtration/adsorption/ion exchange to ensure that any pathogens passing through, or surviving, the first 5 physical treatment steps are inactivated. One of the biggest drawbacks of systems that use carbon adsorption for organics (and chlorine) removal is that there is no method supplied with any system to determine the efficacy of the adsorption system. It is quite possible that subsequent to a serious distribution system event, a homeowner would mistakenly believe that adsorption is occurring, when in fact the carbon's adsorption ability has been seriously compromised or otherwise exhausted. As such, a generic chlorine disinfectant residual test kit is included as part of the system (the vast majority of the time there will be a chlorine residual in the influent to the system from a municipal water treatment system and no residual in the treated water from the Pure-Sip system {which would indicate effective adsorption}). In the event of the failure of the UV disinfection process, specific instructions on how to add chlorine bleach (a common household disinfectant) to the filtered water are included with the system (the generic chlorine residual test kit can be used to determine if an adequate amount of chlorine has been added). Additionally, even if the UV system is working, if a boil water order has been placed by the state or local health department (or during a civil emergency), the chlorine bleach addition instructions will provide peace of mind for homeowners who want additional assurance that the water from the Pure-Sip system is potable. In the event of pump failure, a syringe is provided so that potable water can be obtained by manually forcing water through the system.

### BRIEF DESCRIPTION OF THE SEVERAL VIEWS OF THE DRAWINGS

Two views of the system are provided; Drawing/Sheet 1/2 is a “Bird's eye view,” and Drawing/Sheet 2/2 is a “Frontal elevation.” The system is enclosed in a case measuring ˜22″ wide×˜12″ deep×<18″ high, and is designed to fit in the space typically found in a kitchen between the base and wall cabinets. The “frontal elevation” shows #1, the influent tank, placed above #20, the effluent/treated water tank, to provide positive suction to #4, the system pump. All components of the system are designed to facilitate easy maintenance/replacement, for example: Drawing/Sheet 1/2 shows #14, the chassis (which holds the filter cartridges #7, 11, 12, & 13) as being mounted to #15, a bracket, from which it can easily be removed for routine replacement of the filter cartridges, and Drawing/Sheet 2/2 shows #1, the influent tank, resting on #23, support legs and a frame above #20, the effluent tank, to facilitate easy removal of either tank.

### DETAILED DESCRIPTION OF THE INVENTION

The system is designed to produce potable water wherever there is a 12 volt power source, or other “safe” low voltage, and highly filtered water through the use of a syringe as a power source even in the event of the failure of the system's 12 volt pump and UV portions. As long as one of the 4 available filter cartridge slots employs a <0.45 μm filter (typically the last stage of filtration), pathogenic bacteria (along with the viruses typically attached to each bacteria) will be physically excluded, The syringe connection/quick disconnect at the discharge from the influent tank is followed by a 12V DC centrifugal pump upstream of a flow inhibition device, i.e., an orifice plate or short length of small diameter tubing, engineered to ensure adequate contact time for UV disinfection, as well as adequate contact time for effective GAC adsorption and/or ion exchange. A detailed description of the “Pure-Sip” process is listed below (graphically displayed in drawings 1/2 and 2/2):

Sheet 1/2 is a “Bird's Eye” View of the System/Process:
1—Influent Tank at atmospheric pressure ˜13″W×˜5″D×˜7″H, containing ˜2 gallons
2—Influent Tank discharge/Quick Disconnect Fitting (to allow direct connection to the municipal water supply or for use as a Syringe connection when #4 {the pump} fails, or in emergency situations)
3—Piping between #2 and #4
4—Pump (located below #27—the electrical connection/logic board/system controller), although the pump is also located below #9 and #17 (the UV components), they are not shown on drawing 1/2 to facilitate the description of process flow
5—Flow Control Device (may be an orifice plate or short length of small diameter tubing)
6—Piping between #5 and #7
7—First stage cartridge filtration at <50 μm to remove relatively large particles which can shield pathogens from ultraviolet disinfection supplied by #9
8—piping between #7 and #9
9—First stage UV disinfection (shown numerically on Sheet 1/2 for process convenience of flow description, but not in its actual location {actual location is shown on Drawing 2/2}). This system employs existing technologies and as such, any UV system which can meet EPA standards for microbial inactivation and subsequent use as potable water is acceptable, (for example: Technologies which provide a “contact chamber” on either side of a single lamp, a reflective surface {ref. 7252763 Keunnen}, 2 side by side contact tubes wrapped around a single lamp, or those that employ separate UV lamps and contact chambers for pre-disinfection and post disinfection), and that depending on the existing technologies employed, #9 and #17 (2^{nd} stage UV disinfection) may use the same UV source. Please note that to gain EPA acceptance, the system includes filtration which will provide adequate particle removal to ensure that pathogens cannot be occluded and thereby avoid adequate contact with the UV energy
10—Piping from #9 to #11
11, 12, & 13—2^{nd}, 3^{rd}, and 4^{th} stage cartridge filtration, and/or adsorption, and/or ion exchange, respectively; all three are at ≤3.0 micron and may be in descending sizes. At least one of #11, 12, or 13 filter cartridges employs activated carbon adsorption. #7, 11, 12, & 13 (filter cartridges) are replaceable as needed and screw on to #14 (the Chassis).
14—Chassis that holds #7, 11, 12, & 13 (filter cartridges); the chassis provides: Fittings to connect #6 (piping) to #7's supply port, #7's exit port to #8 (piping), #10 (piping) to #11's supply port, hydraulic connection ports/piping to supply #11, 12, and 13, and an exit port from the chassis from #13 to #16 (piping). For clarification's sake, the filter cartridges screw into the chassis, and the chassis provides the fittings/piping needed to transfer water between the cartridges
15—Mounting bracket for #14 (the chassis) is attached to #25 (the system housing/case, which is shown on Sheet 2/2)
16—Piping from #13 (4^{th} stage filtration) to #17 (second stage UV disinfection {shown on drawing 2/2})
17-20 are shown on drawing 1/2 for clarification of flow only (17 is second stage UV disinfection, 18 is the piping between 17 and 19 {the quick disconnect fitting on the treated water/effluent tank}, and 20 is the treated water/effluent tank); their actual locations are shown on Sheet 2/2
21-26 are not shown on Sheet 1/2, and are shown on Sheet 2/2
27—Electrical connection/logic board/system controller (attached to right side of #25, the system housing/case {shown on Sheet 2/2}; grommets are provided to allow 12 VDC supply from the right side of #25, the system housing/case)
28—System on/off switch
29—LED to indicate UV lamp is on (depending on the UV technology employed at “9” above, there may be 2 LEDs at 29)
30—Removable lid to allow filling of Influent Tank, replacement of filter cartridges, and system maintenance

Sheet 2/2 is a “Frontal Elevation” of the System/Process:
1—Influent Tank
2—Influent Tank discharge/Quick Disconnect Fitting (to allow direct connection to the municipal water supply or for use as a Syringe connection when #4 {the pump} fails, or in situations in which potable municipal water is unavailable)
3—Piping between #2 and #4
4—A 12 VDC (or other safe low voltage supply) powered centrifugal Pump (mounted to #25, the system housing/case base)
5—Flow Control Device
6—Piping between #5 and #7
7—first stage cartridge filtration—shown to facilitate the description of the path of flow, but not in its actual location (it is shown graphically on Sheet 1/2)
8—Piping between #7 and #9
9—1^{st} stage UV disinfection
10-16—Not shown on Sheet 2/2 as they are essentially occluded from view, and are shown on Sheet 1/2 (for clarification's sake, #10 is the piping from #9 to #11; #11, #12, & #13 are the 2^{nd}, 3^{rd}, and 4^{th} stage filtration, and/or adsorption, and/or ion exchange cartridges, #14 is the Chassis that holds cartridges #7, #11, #12, & #13. #15 is the Mounting Bracket for #14 (the Chassis), and #16 is the Piping from #13 to #17 {second stage UV disinfection})
17—Second stage UV disinfection
18—piping between #17 and #19
19—Quick disconnect fitting for those wishing to connect the system to a dedicated faucet at the sink); it is attached to the upper right side of #20 (Treated Water/Effluent Tank).
20—The treated water/effluent tank, at ˜13″W×˜5″D×˜7″H, contains ˜2 gallons and is slightly bigger than #1 (the influent tank) to avoid accidental spills
21—Treated water discharge piping and faucet/drain penetrates through #25 (the system housing/case)
22—Overflow piping threaded into 20
23—Support legs and frame for influent Tank A1
24—Removable front cover
25—System housing/case (outside dimensions of ˜22″W×12″D×<18″H)
26—4 support legs for #25 (the system housing/case), located at each corner

1. The invention claimed is a countertop point of use water treatment system which will fit in the typical 18″ space found between overhead and base cabinets in a kitchen, and is powered by 12 volt DC (other “safe” low voltages are included), it incorporates the following devices within the system housing/case, such that operation/flow progresses through the system in the following manner:
a. Operation of the system is initiated by removing the lid of the system housing/case, and filling the open topped influent tank measuring ˜13″W×˜5″D×˜7″H;
i. Water is added to the influent tank until the water reaches an indicated mark on the interior of the influent tank;
ii. At the bottom right corner of the influent tank, there will be a generic quick disconnect fitting, so as to allow an individual to attach the claimed device to an ordinary faucet or standard piping for drinking water;
b. A system momentary power switch is turned on to begin the function of the system via the electrical connection/logic board/system controller, a time delay relay is included in the system controller which delays the pump start until the UV power source is at ≥40,000 microwatt-sec/sq. cm., the system controller includes a timer which shuts off the system after “X” (variable) seconds (guidance will be included that those who choose to install the system under the counter {or teed from the sink faucet} and pipe it to a dedicated faucet such that, to extend the life of the UV supply, that ˜1-2 gallons be collected from the dedicated faucet each time the momentary switch is activated);
c. Water flows from the influent tank through the influent quick disconnect fitting and then through piping to the pump;
d. The pump forces water through an orifice plate or section of small diameter piping, engineered to inhibit the flow of water to ensure adequate contact time with UV to comply with EPA and/or state standards;
e. Flow then passes through a filter housing containing a <50 micron pore size particle/sediment filter;
f. Flow then passes through an ultraviolet contact chamber where it comes in contact with an ultraviolet source at ≥40,000 microwatt-sec/sq. cm. for disinfection;
i. The UV Source includes an LED which is located adjacent to the power switch;
ii. As long as the LED is illuminated the user can be confident that the ultraviolet disinfection process is performing properly;
iii. Depending on the UV configuration, either 1 or 2 UV bulbs will be included, for systems with 2 UV bulbs, a LED for each bulb will be included;
g. After passing through UV Chamber #1, the flow passes through a filter cartridge/housing containing a ≤3.0 micron pore size filter (the particle/sediment filter {at “1.e.” above} is the first of four cartridge/filter housings), which is mounted onto a chassis that provides for flow from the particle/sediment filter to UV chamber #1 and then to next 3 filter housings;
i. The three filter housings each contain one cartridge, depending on the source water, the three cartridges will be used for particle removal, and/or activated carbon adsorption, and/or ion exchange;
ii. As long as at least one of the three cartridges is rated at <0.45 microns pore size (typically the last cartridge), bacteria will be physically filtered out;
h. After passing through the three filter housings, the water is subjected to UV disinfection at ≥40,000 microwatt-sec/sq. cm. a second time to inactivate opportunistic or frank pathogens which survive treatment in the first stage of UV disinfection;
i. After the second stage of UV disinfection the water is piped to the treated water tank;
i. At the top right side of the treated water tank, there will be a quick disconnect fitting to allow an individual to attach the claimed device to a dedicated faucet at the sink;
ii. There is a ¾″ NPT female socket on the left side of the treated water tank into which a faucet is threaded to draw off treated water (depending on faucet style, a short nipple may be installed between the female socket on the treated water tank and a faucet);
iii. An overflow pipe ensures that if the effluent tank is overfilled that the excess spills outside the system case to avoid damaging any components.

2. A system according to claim 1 which is portable so that it may be used anywhere a 12 Volt DC (or other “safe” low voltage source) is available, the low voltage powers the UV source, the LED which indicates the UV is operating, the pump, and the system controller.

3. A system according to claim 1 which includes a syringe which will allow water to be manually forced through the influent quick disconnect fitting at 1.a.ii. in the event of pump failure, unavailability of a low voltage power source, or civil emergency, the influent quick disconnect fitting allows those wishing to connect the system to the regular faucet on the sink or to the supply line under the counter to do so, the same applies to the effluent quick disconnect fitting which would be upstream of a sink faucet dedicated to providing water treated by the system.

4. A system according to claim 1 which includes a generic chlorine disinfectant residual test kit (for example, a kit using commonly available chlorine test strips for a swimming pool), absence of chlorine in the unit's treated water provides a method by which a user may verify the efficacy of the carbon block filter's adsorption of organic contaminants;

5. A system according to claim 1 which includes instructions on substituting chlorine disinfection for UV disinfection in the event of UV system failure, or during a civil emergency in which the UV system is working yet the homeowner wants additional assurance that the water will be safe to drink, the homeowner needs to;
a. Draw off filtered water from the treated water tank and use the generic chlorine test kit to check the chlorine level, if the adsorption process is working properly, there should be no chlorine residual, if there is chlorine, the adsorptive capacity of the granular activated carbon has been exhausted and the system can't be relied upon for removal of organics until a new adsorption cartridge is installed;
b. With the failure of the UV system, even if chlorine is detected, additional chlorine must be added to ensure adequate disinfection by adding ˜1 ml (about 10 drops from a typical household eyedropper) of household bleach (typically 5.25% available chlorine), to ˜2 gallons of water from the treated water tank, robustly stirring it, and letting the bleach react with the water for 15 minutes, the generic chorine disinfectant residual test kit can then be used to test the chlorine residual and a residual of ˜1-3 mg/l should be indicated, if it is below 0.5 mg/l, another 1 ml of bleach should be added, and the process repeated, as many times as it takes, until a residual of ˜1-3 mg/l is measured.

6. A system according to claim 1 which includes instructions for those who need to rely upon the Pure-Sip system to produce potable water on a long term basis from a raw water source (such as a well, stream, or lake), that they need to have an analysis done on their raw water to ensure that they (or a consultant) select filtration, and/or adsorption, and/or ion exchange, cartridges for the Pure-Sip system which will remove said contaminants to meet EPA standards for potable water.
